(19) United States
(12) Patent Application Publication
(10) Pub. No.: US 2008/0122387 A1
(43) Pub. Date: May 29, 2008

(54) LAMP STATE DETERMINING CIRCUIT AND CONTROLLER THEREOF

(75) Inventor: Huan-Wen Chien, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: BEYOND INNOVATION TECHNOLOGY CO., LTD., Taipei City (TW)

(21) Appl. No.: 11/622,470

(22) Filed: Jan. 12, 2007

(30) Foreign Application Priority Data
Nov. 7, 2006 (TW) 95141130

(51) Int. Cl. H05B 41/36; H02M 3/335

(52) U.S. Cl. 315/307; 363/21.02

(57) ABSTRACT

A DC/AC inverter for driving a load is provided. The DC/AC inverter includes a switch device, a resonant tank, a voltage detecting circuit, and a controller. The switch device is coupled to a DC power source. The resonant tank is coupled to the switch device and the load, and converts power of the DC power source transmitted from the switch device to an AC signal, so as to drive the load. The voltage detecting circuit is coupled to the load, and generates a voltage detecting signal according to a voltage of the load. The controller is coupled to the voltage detecting device and the switch device, and controls a magnitude of the power of the DC power source transmitted to the resonant tank through the switch device. The controller determines whether or not to change an operating frequency thereof according to the voltage detecting signal.

### CROSS-REFERENCE TO RELATED APPLICATION

This application claims the priority benefit of Taiwan application serial no. 95141130, filed Nov. 7, 2006. All disclosure of the Taiwan application is incorporated herein by reference.

### BACKGROUND OF THE INVENTION

1. Field of Invention

The present invention relates to a DC/AC inverter for fluorescent lamp application. More particularly, the present invention relates to a DC/AC inverter control circuit varying frequency according to lamp states.

2. Description of Related Art

In the conventional art, a typical DC/AC inverter for fluorescent lamp application, which includes a full-bridge topology and a resonant tank, converts an input DC voltage source into an AC of high voltage for driving a fluorescent lamp. To ensure the fluorescent lamp lighting stably, i.e., the luminance of the fluorescent lamp does not change with the change of the input voltage, a negative feedback control circuit is often applied in the design to stabilize an operating current of the fluorescent lamp.

As an operating voltage of the fluorescent lamp and frequency-gain characteristic curve of the resonant tank vary when the fluorescent lamp striking, the inverter controller provides a control signal according to a state of the lamp. The state of the lamp is determined conventional by detecting whether or not a lamp current exceeds a certain value.

As shown in FIG. 1, a lamp driving circuit includes a controller 110, a switch device 120, a resonant tank 130, a fluorescent lamp 140, a lamp current detecting circuit 150, and a lamp voltage detecting circuit 160. The controller 110 controls an ON/OFF state of the switch device 120 according to a feedback signal FB and a lamp state indicating signal CS generated by the lamp current detecting circuit 150 and a lamp voltage signal OV generated by the lamp voltage detecting circuit 160, so as to further control the power transmitted to the resonant tank 130 by the input voltage Vin. The resonant tank 130 converts the power of the input voltage Vin into an AC signal, so as to drive the fluorescent lamp 140. When the lamp driving circuit is just started but the lamp is not conducted (struck), the feedback signal FB is low, the controller controls the switch device 120 to transmit more power to the resonant tank 130, and the voltage of the fluorescent lamp 140 increases gradually.

When the lamp voltage signal OV reaches a predetermined value, the controller 110 adjusts the output power, so as to maintain the voltage of the fluorescent lamp 140 near a predetermined driving voltage value corresponding to the predetermined value. The fluorescent lamp 140 is then struck after being maintained at the appropriate predetermined driving voltage for a period of time. At this time, the controller 110 further determines whether or not the lamp is struck by determining whether or not the lamp state indicating signal CS generated by the current detecting signal 150 is higher than a predetermined value. When the controller 110 determines that the lamp is struck, the frequency is varied, i.e., a higher frequency for striking the lamp is changed to a frequency suitable for the normal operation of the lamp.

However, referring to FIG. 2, an equivalent capacitor Clk exists between the fluorescent lamp 140 and a housing 170 or other external devices, so a part of the lamp current will flow out from the equivalent capacitor Clk. Therefore, the lamp state indicating signal CS of the lamp current detecting circuit 150 only represents a part of the lamp current value, instead of the real lamp current value. Thus, after the fluorescent lamp 140 is actually struck, the controller 110 will still determine that the fluorescent lamp 140 is not struck, and operates at the higher frequency for striking the lamp. Moreover, the impedance of the equivalent capacitor Clk is lower when the frequency for striking the lamp is higher, so more lamp current will flow out from the equivalent capacitor Clk, which makes the detection for the lamp state more difficult. In addition, the possible paths of leakage current become more if the length of the fluorescent lamp is greater, which also make it more difficult to determine whether or not the lamp is struck according to the current detecting signal CS.

### SUMMARY OF THE INVENTION

The present invention is directed to a DC/AC inverter capable of determining a load state by detecting a terminal voltage of the load and adjusting an operating frequency of the inverter accordingly.

The present invention is also directed to a controller for controlling the DC/AC inverter. The controller uses voltage variation characteristics when the load state changes, determines the load state according to relationship between the terminal voltage of the load and a reference voltage, and adjusts the operating frequency of the inverter according to the determination.

In order to achieve the above objectives, the present invention provides a DC/AC inverter for driving a load. The DC/AC conversion driving circuit comprises a switch device, a resonant tank, a voltage detecting circuit, and a controller. The switch device is coupled to a DC power source. The resonant tank is coupled to the switch device and the load, and converts power of the DC power source transmitted from the switch device to an AC signal, so as to drive the load. The voltage detecting circuit is coupled to the load, and generates a voltage detecting signal according to a voltage of the load. The controller is coupled to the voltage detecting device and the switch device, and controls a magnitude of the power of the DC power source transmitted to the resonant tank through the switch device. The controller determines whether or not to change an operating frequency thereof according to the voltage detecting signal.

The present invention also provides a controller for controlling a DC/AC inverter to drive a load. The controller comprises a frequency generator, a pulse width modulated circuit, a driving circuit, and a lamp state determining circuit. The frequency generator is used to generate a reference signal. The pulse width modulated circuit is coupled to the frequency generator, and generates a pulse width modulated signal according to the reference signal. The driving circuit is coupled to the pulse width modulated circuit, and generates a plurality of driving signals according to the pulse width modulated signal. The lamp state determining circuit comprises a first determining circuit for determining whether or not to generate a first determining signal according to a voltage detecting signal and a first reference voltage. The frequency generator determines whether or not to adjust a frequency of the reference signal according to the first determining signal.

The present invention will be more comprehensible with reference to the accompanying drawings and the detailed illustration below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit diagram of a conventional lamp driving circuit.

FIG. 2 is a schematic view of current leakage paths of the lamp current.

FIG. 3 is a schematic view of striking curves of the fluorescent lamp.

FIG. 4 is a schematic circuit diagram of a DC/AC inverter according to an embodiment of the present invention.

FIG. 5 is a schematic circuit diagram of a lamp state determining circuit according to an embodiment of the present invention.

FIG. 6 is a schematic circuit diagram of a lamp state determining circuit according to another embodiment of the present invention.

FIG. 7 is a schematic circuit diagram of a lamp state determining circuit according to yet another embodiment of the present invention.

FIG. 8 is a schematic circuit diagram of a lamp state determining circuit according to yet another embodiment of the present invention.

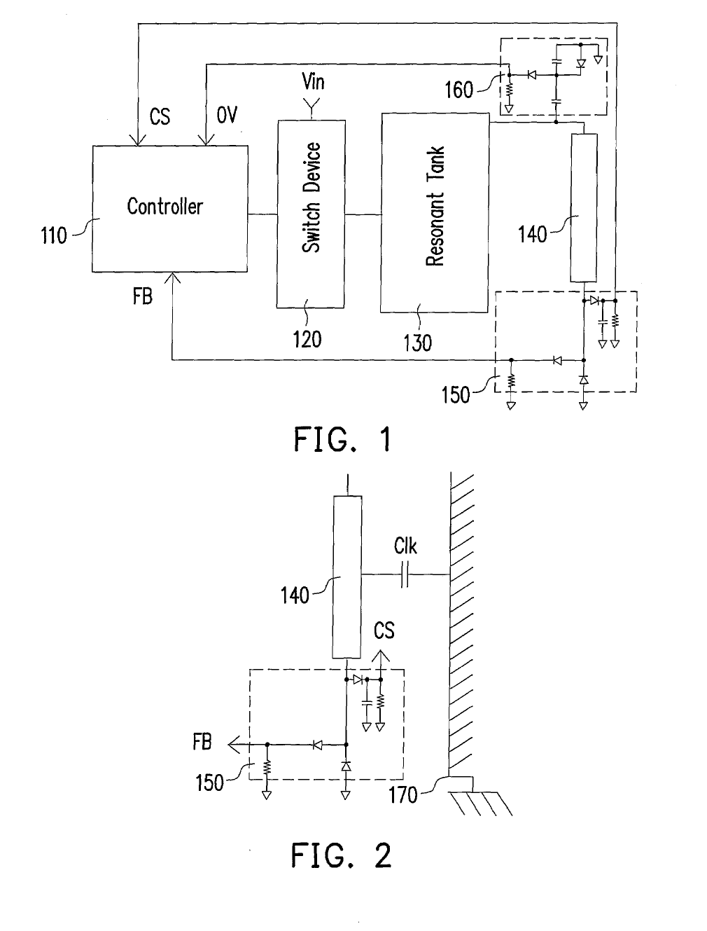

### DESCRIPTION OF EMBODIMENTS

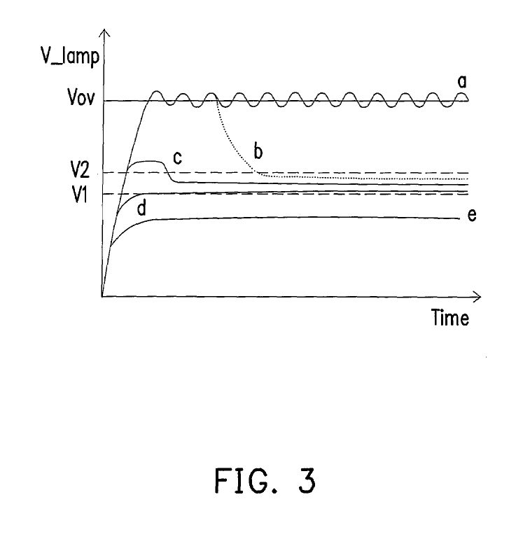

FIG. 3 illustrates possible situations when a fluorescent lamp is struck, in which curves a, e are situations when the lamp fails to be struck, and curves b, c, and d are situations when the lamp is struck. Curve a shows a situation when the lamp is damaged. Therefore, though an adequate voltage Vov (the maximum voltage for striking the fluorescent lamp) is provided, the fluorescent lamp still cannot be struck and the lamp voltage is maintained at Vov. Curve b shows the voltage variation before and after a fluorescent lamp is struck in an environment where the lamp is difficult to be struck (e.g., when the ambient temperature is extremely low, or in an extremely dark environment). After the lamp is struck, the lamp voltage rapidly reduces to a normal operating voltage range.

Curve c shows a situation where the lamp is relatively easy to be struck, for example, when the ambient temperature is high, when external light exists, or when the condition of the lamp is quite fine, etc., so the lamp is struck before the lamp voltage reaches Vov, and then the lamp voltage reduces to the normal operating voltage range. Curve d shows a situation when the condition is the most preferred, for example, when the lamp condition is perfect, when the lamp is just extinguished and the lamp temperature is still high, or when the external light is sufficient, etc. At this time, the lamp does not struck with a high voltage as shown in curves b and c, but is struck directly once the voltage increases to reach the normal operating voltage range. Curve e shows a situation that the lamp cannot be struck as the lamp cannot receive enough driving voltage, which may be caused by a short circuit of an output terminal of the resonant tank.

Based on the possible lamp conditions described above, the present invention sets two voltages V1 and V2. V1 is a lowest possible voltage when the lamp is in the normal operation (i.e., after the lamp is struck), and V2 is a highest possible voltage when the lamp is in the normal operation (i.e., when the lamp is struck). The two voltages V1, V2 are used to determine whether or not the lamp is struck. Thus, the problem of error determination according to the lamp current in the conventional art is prevented.

Several embodiments are given below to illustrate possible schemes of implementation of the present invention. However, the present invention is not limited by the following embodiments. A low level signal or a high level signal mentioned in the description below can be interpreted as that, the signal at the low level represents that the signal is not generated, and the signal at the high level represents that the signal is generated, which are illustrated here in advance.

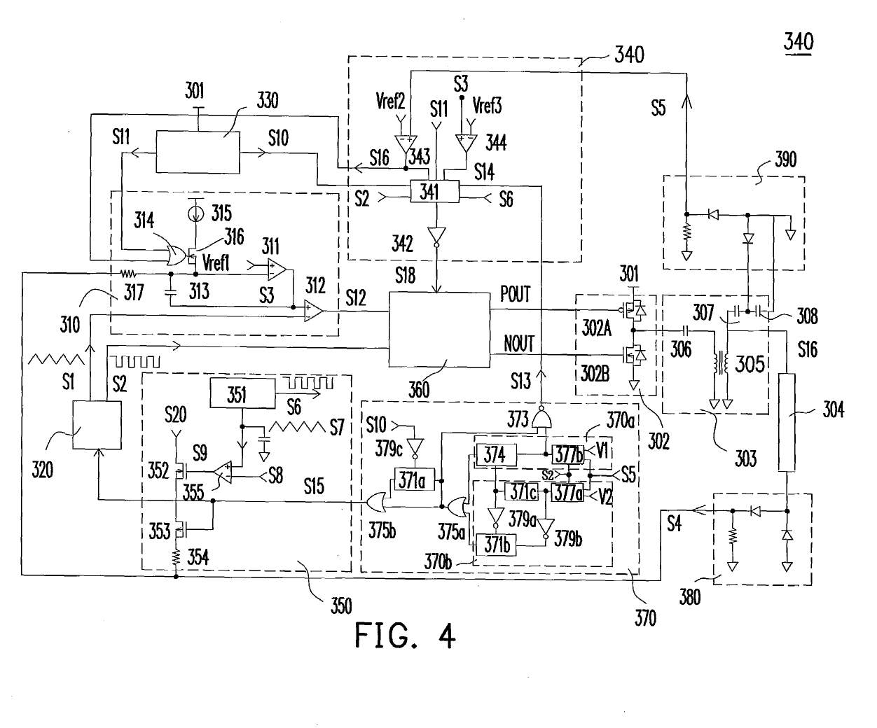

FIG. 4 is a schematic circuit diagram of a DC/AC inverter according to an embodiment of the present invention. A DC/AC inverter 300 is used for driving a fluorescent lamp 304, and includes a pulse width modulated circuit 310, a frequency generator 320, a timer 330, a protection circuit 340, a dimming circuit 350, a driving circuit 360, a lamp state determining circuit 370, a switch device 302, a resonant tank 303, a current detecting circuit 380, and a voltage detecting circuit 390. The connections of the above elements are as follows.

A DC voltage source 301 is coupled to the switch device 302. An output terminal of the switch device 302 is coupled to an input terminal of the resonant tank 303. An output terminal of the resonant tank 303 is coupled to a terminal of the fluorescent lamp 304. The resonant tank of the present invention can be a transformer of any type, such as a magnetic transformer, or a piezoelectric ceramic transformer, but is not limited to be the above types. Two terminals of the fluorescent lamp 304 are coupled to the current detecting circuit 380 and the voltage detecting circuit 390 respectively. The current detecting circuit 380 is also coupled to the pulse width modulated circuit 310, and the pulse width modulated circuit 310 is coupled to the frequency generator 320 and the driving circuit 360. The driving circuit 360 is coupled to the switch device 302 to form a so-called control loop connection.

In this embodiment, the DC/AC inverter is a half-bridge DC/AC inverter. However, the present invention is also applicable to full-bridge and push-pull DC/AC inverters, and is not limited to the aforementioned circuits. In the embodiment, the switch device 302 includes two power switches 302A, 302B. The power switch 302A can be a P-type metal oxide semiconductor (PMOS) power switch, and the power switch 302B can be an N-type metal oxide semiconductor (NMOS) power switch. However, the two power switches 302A, 302B are not limited to metal oxide semiconductor (MOS) power switches, and can also be other transistor switches, such as BJTs of NPN type or PNP type.

The frequency generator 320 generates a triangular wave signal S1 and a pulse signal S2 of the same frequency. However, the present invention is limited to use the triangular wave signal, and all ramp signals or sawtooth wave signals are applicable to the present invention.

The current detecting circuit 380 is connected to the fluorescent lamp 304 in series, and provides a load current signal S4 to indicate the value of a current flowing through the fluorescent lamp. The voltage detecting circuit 390 detects a load voltage signal S5 to indicate a terminal voltage of the fluorescent lamp 304 with resonant capacitors 307, 308 in the resonant tank 303 connected to the fluorescent lamp 304 in parallel.

The pulse width modulated circuit 310 includes an inverting integrator composed of an error amplifier 311, a resistor 317 and a capacitor 313, and a comparator 312. Moreover, the pulse width modulated circuit 310 further includes a controlled current source 315, which is connected to an inverting input terminal of the error amplifier 311 via a switch 316.

The protection circuit 340 includes a logic control circuit 341. The protection circuit 340 receives an abnormal signal S13, the signal S5 indicating the terminal voltage of the fluorescent lamp 304, and an error amplifying signal S3 of the error amplifier 311 in the pulse width modulated circuit 310.

The dimming circuit 350 includes a dimming frequency generator 351. A triangular wave signal S7 generated by the dimming frequency generator 351 is sent to a non-inverting input terminal of a comparator 355, and a dimming control signal S8 is sent to an inverting input terminal of the comparator 355. After comparison, a dimming pulse signal S9 is generated, which controls the time that a dimming voltage S20 is sent to the pulse width modulated circuit 310 through controlling switches 352 and 353.

It should be noted that the structures of the protection circuit 340, the dimming circuit 350, and the pulse width modulated circuit 310 described in detail above are to illustrate the operational relationship between the lamp state determining circuit 370 and various circuits coupled there-to, but are not to limit the design of the circuits.

The driving circuit 360 receives an output S12 of the pulse width modulated circuit 310, the pulse signal S2 output from the frequency generator 320 and an output signal S18 output from the protection circuit 340 and accordingly generates two driving output signals POUT, NOUT, so as to control the transistor switches 302A, 302B in the switch device 302 respectively.

In this embodiment, the timer 330 generates a reset signal S11 and a time out signal S10. The reset signal S11 serves as a reset signal for analog or digital circuits (e.g., the pulse width modulated circuit 310 and the logic control circuit 341) in the entire circuit, such that the circuits is reset at an appropriate time and output signals of original states. Thus, improper operation of corresponding circuits caused by improper signals generated when the circuits are started or in other situations are prevented. The time out signal S10 is a time signal indicating the time that the lamp should be struck normally. When the time out signal S10 is output, it indicates that the lamp should be in the ON state normally. The circuits not suitable for operating before the lamp is struck, e.g., the protection circuit 340, start to operate after receiving the time out signal S10.

The frequency generator 320 is also controlled by a signal S15, which is generated by the lamp state determining circuit 370 for indicating whether or not the fluorescent lamp is struck. When the fluorescent lamp is not struck, the frequency generator 320 generates signals at a frequency for striking the fluorescent lamp to the driving circuit 360. When the fluorescent lamp 304 is struck, the frequency generator 320 generates signals at a fluorescent lamp operating frequency. The resonant frequencies of the resonant tank 303 when the fluorescent lamp is struck or not struck are different. Such design providing different operating frequencies according to different states for the lamp ensures that the system operates at an appropriate operating frequency (e.g., near the resonant frequency) no matter whether or not the fluorescent is struck, so the system operates more efficiently.

The lamp state determining circuit 370 includes a first determining circuit 370a and a second determining circuit 370b. The first determining circuit 370a and the second determining circuit 370b respectively include determiners 377b and 377a. The determiner 377a is used to determine whether or not the situation of the lamp belong to lamp striking curves a, b, or c in FIG. 3, and the determiner 377b is used to determine whether or not the situation of the lamp belong to lamp striking curves d and e in FIG. 3. In this embodiment, the load voltage signal S5 of the voltage detecting circuit 390 is a half-wave signal, so the determiners 377a, 377b are used to determine whether or not the voltage amplitude of each half wave is higher than comparison voltages V2, V1. When it is determined that the amplitude of the signal S5 is higher than the comparison voltages in a certain period, the high level signal having an appropriate duration is output (e.g., a duration equal to or over a period of the signal S2).

The lamp state determining circuit 370 outputs the signals S13 and S15 respectively. The signal S13 is transmitted to the protection circuit 340, such that the protection circuit 340 determines whether or not to cease the operation of the driving circuit 360 according to the signal S13. The signal S15 is transmitted to the dimming circuit 350 and the frequency generator 320, such that the dimming circuit 350 determines whether or not to perform the dimming according to the signal S15, and the frequency generator 320 determines whether or not to perform the frequency variation according to the signal S15. Generally, the dimming circuit 350 starts the dimming (adjusting the power of the DC power source 301 transmitted to the resonant tank 303) at the same time as the frequency generator 320 varies the operating frequency.

In the normal state, more detailed operation of this embodiment is described as follows.

When the system is supplied with power and started, the reset signal S11 generated by the timer 330 turns on a switch 316 through an OR logic 314, such that the current source 315 is connected to the inverting input terminal of the error amplifier 311, and forces the voltage on the inverting input terminal to be higher than a reference voltage Vref1. Thus, the output of the error amplifier 311 is forced to be low, such that the duty cycle of the output S12 of the pulse width modulated circuit 310 is changed to 0%. After the 0% output signal S12 passes through the driving circuit 360 of this embodiment, the duty cycles of POUT and NOUT are both changed to 0%, such that the switches 302A, 302B are turned off.

The timer 330 then stops outputting the reset signal S11 after a predetermined period of time, and the current source switch 316 is turned off. At this time, the pulse width modulated circuit 310 starts to operate, the inverting input terminal of the error amplifier 311 turns into a state of being lower than the reference voltage Vref1 because the fluorescent lamp 304 is not struck. The signal S3 output from the error amplifier 311 gradually increases according to the negative feedback control principle. Then, after the comparison of the signal S3 and the triangular wave S1, the comparator 312 sends out a pulse width modulation signal S12. The driving circuit 360 receives the signal S12 and the pulse signal S2 to generate two signals POUT, NOUT, which are respectively used to control the ON or OFF of the transistor switches 302A, 302B of the switch device 302, so as to adjust the power output to the fluorescent lamp 304. The duty cycle of the pulse width modulation signal S12 gradually becomes wider and increases, so the driving voltage of the fluorescent lamp 304 will gradually increase accordingly.

As shown in curve b of FIG. 3, the driving voltage output from the resonant tank 303 to the fluorescent lamp 304 increases gradually. When the voltage of the fluorescent lamp 304 is higher than the comparison voltage V1 and is lower than the comparison voltage V2, the determiner 377a in the lamp state determining circuit 370 outputs the low level signal, and the determiner 377b outputs the high level signal. A delay circuit 374 outputs the high level signal after a predetermined period of delay after receiving the high level signal from the determiner 377b. Moreover, a latch circuit 371c outputs a low level signal after receiving the low level signal from the determiner 377a, and an inverter 379a outputs a high level signal to a latch circuit 371b, such that the latch circuit 371b is in the reset state and does not work.

Next, the voltage of the fluorescent lamp 304 becomes higher than the comparison voltage V2, the determiner 377a also starts to output a high level signal. The latch circuit 371c continuously output a high level signal after receiving the high level signal from the determiner 377a. In principle, the delay circuit 374 will be in the reset state and not work after receiving the high level signal from the latch circuit 371c in the predetermined period of delay and so the delay circuit 374 did not output the high level signal.

Furthermore, the inverter 379a starts to output a low level signal to the latch circuit 371b so that the latch circuit 371b starts to work. At the same time, the high level signal generated by the determiner 377a is transferred into a low level signal by the inverter 379b, so the latch circuit 371b also outputs the low level signal at this time. As the two input signals of the OR logic 375a are both low level signals, the low level signals will be output. In addition, the time out signal S10 of the timer 330 is still at the low level, and the inverter 379c makes the latch circuit 371a to enter the reset state and not work. Therefore, two input signals of the OR logic 375b are also low logic signals, and the low logic signals will be output.

After the driving voltage of the fluorescent lamp 304 finally increases to a predetermined lamp striking voltage Vov, the comparator 343 in the protection circuit 340 detects that the signal S5 indicating the terminal voltage of the fluorescent lamp exceeds a predetermined reference voltage Vref2, and sends out a signal S16 indicating that the terminal voltage of the fluorescent lamp exceeds, and then turns on the switch 316 via the OR logic gate 314. The current of the current source 315 flows into the inverting input terminal of the error amplifier 311, and reduces the level of output S3 of the error amplifier 311. Next, the duty cycle of the pulse width modulation signal S12 is shortened, so as to reduce the power transmitted to the terminals of the fluorescent lamp. Next, when it is detected that the signal S5 indicating the terminal voltage of the fluorescent lamp is lower than the predetermined reference voltage Vref2, the current source switch 316 is turned off, such that the level of output S3 of the error amplifier 311 increases. Thus, the terminal voltage of the fluorescent lamp is stabilized under the negative feedback control, and maintains near the predetermined lamp striking voltage Vov continuously.

Once the fluorescent lamp is struck and conducted under the adequate driving voltage Vov and time period, according to the characteristics of the fluorescent lamp, the terminal voltage S16 of the fluorescent lamp will suddenly drop by over a half to an operating voltage, which is an ON voltage and is nearly fixed. The operating voltage is between the voltages V1 and V2, as shown in curve b of FIG. 3. At this time, the output of the determiner 377a in the lamp state determining circuit 370 becomes a low level signal, and then is output as a high level signal via the inverter 379b. The latch circuit 371b continuously outputs the high level signal after receiving the high level signal of the inverter 379b. At this time, the OR logic 375a also outputs the high level signal, and the OR logic 375b also outputs the high level signal S15 indicating that the fluorescent lamp 304 is struck. The frequency generator 320 changes the frequencies of the signals S1, S2 to a normal operating frequency of the lamp after receiving the signal S15 indicating that the lamp is struck. The dimming circuit 350 starts to perform the dimming function after receiving the signal S15 indicating that the lamp is struck.

The situation shown as curve c in FIG. 3 is similar to the situation shown as curve b, while the difference only lies in that the driving voltage of the fluorescent lamp 304 does not reach the voltage Vov, so the negative feedback control mechanism of the current source switch 316 will not be started. Therefore, the situation of curve c is not described here again.

As shown in curve d of FIG. 3, the driving voltage of the fluorescent lamp 304 does not exceed the voltage V2, so the output of the determiner 377a is always the low level signal, which passes through the latch circuit 371c and the inverter 379a to generate a high level signal, such that the latch circuit 371b is always in the reset state and does not work. The delay circuit 374 outputs the high level signal after a predetermined period of delay after receiving the high level signal of the determiner 377b, such that the OR logic 375a also outputs the high level signal. The OR logic 375b outputs the high level signal S15 indicating that the fluorescent lamp 304 is struck after receiving the high level signal of the OR logic 375a. The predetermined delay period of the delay circuit 374 is a period long enough to strike a normal fluorescent lamp, which can be the same as the time out signal S10, or can be shorter than the time out signal S10. When the predetermined delay is shorter than the time out signal S10, and the fluorescent lamp 304 is not really struck, the frequency generator 320 changes the frequencies of the signals S1, S2 to the normal operating frequency of the lamp after receiving the signal S15 indicating that the lamp is struck, and the terminal voltage of the fluorescent lamp 304 is lower than the voltage V1, such that the signal S15 returns to the low level. Therefore, the frequency generator 320 changes the frequencies of the signals S1, S2 to the lamp striking frequency for a second time, and tries to restrick the fluorescent lamp 304 until the fluorescent lamp 304 is really struck or the time out signal S10 is generated.

If the striking process of the fluorescent lamp is abnormal, and resulting in the curves a, e as shown in FIG. 3, the detailed operation process of the lamp state determining circuit 370 is as follows.

When the situation of curve a of FIG. 3 occurs, the process that the terminal voltage of the fluorescent lamp rises to the voltage Vov is as shown in curve b, and is not described again here. Next, as the fluorescent lamp cannot be struck, the terminal voltage of the fluorescent lamp maintains near the voltage Vov. The delay circuit 374 is always in the reset state and does not work, and the latch circuit 371b keeps outputting the low level signal. Therefore, the signal S15 is always a low level signal indicating that the fluorescent lamp is not struck.

As shown in curve e of FIG. 3, the terminal voltage of the lamp always does not exceed the voltage V1, and the determiners 377a, 377b keeps outputting the low level voltage, so the delay circuit 374 keeps outputting the low level signal, and the latch circuit 371b is always in the reset state and does not work. Therefore, the signal S15 is always a low level signal indicating that the fluorescent lamp is not struck.

The latch circuit 371a is in the reset state and does not work before the time out signal S10 is sent out. When the fluorescent lamp 304 is struck successfully before the time out signal S10 is sent out, after the time out signal S10 is sent out, the time out signal S10 enables the latch circuit 371a to start to work through the inverter 379c. At this time, the latch circuit 371a sends out and latches the high level signal after receiving the high level signal of the OR logic 375a. Thus, after the time out signal S10 is sent out, the lamp state determining circuit 370 sends out the signal S15 and latches the signal S15 at the high level signal indicating the striking of the lamp. However, if the fluorescent lamp 304 is not successfully struck before the time out signal S10 is sent out, the lamp state determining circuit 370 will output the low level signal indicating that the lamp is not struck after the time out signal S10 is sent out.

In addition, the lamp state determining circuit 370 sends out the signal S13, and informs the protection circuit 340 the state of the fluorescent lamp 304. The protection circuit 340 starts to perform the protection after receiving the time out signal S10. If the fluorescent lamp 304 is struck before the time out signal S10 is sent out, the terminal voltage of the fluorescent lamp 304 will definitely be higher than the voltage V1, such that the determiner 377b sends out the high level signal, and the OR logic 375a outputs the high level signal as well. Therefore, two input signals of an NAND logic 373 are both high level signals, and low level signals indicating that the fluorescent is in the normal state will be output. However, when the fluorescent lamp 304 is struck normally but extinguishes during the operation such that the terminal voltage is lower than the voltage V1, the NAND logic 373 outputs the high level signal S13 representing that the fluorescent lamp state is abnormal, such that the protection circuit 340 also outputs the high level protection signal S18. After the driving circuit 360 receives the high level protection signal S18, the switch device 302 is switched to stop transmitting the power of DC voltage source 301 to the resonant tank 303.

According to another aspect, if the fluorescent lamp 304 is not struck before the time out signal S10 is sent out, 375a outputs the low level signal, and so the NAND logic 373 outputs the high level signal S13 indicating that the fluorescent lamp state is abnormal, such that the switch device 302 stops transmitting the power to the resonant tank 303.

Moreover, if the lamp is struck and the dimming circuit 350 operates, the terminal voltage of the lamp is periodically switch among zero voltage and the normal operating voltage. In the present invention, the protection circuit 340 uses a digital count unit to count by a pulse signal S6 generated by the low-frequency dimming frequency generator 351. Counting function is started after the high level signal S13 indicating the fluorescent lamp state is abnormal is received. If the signal S13 still remains at the high level signal after a predetermined time according to the counting of the digital count unit, the logic control circuit 341 sends out the output stop signal S18 to the driving circuit 360. Thus, the misdetermination of the extinguishment of the fluorescent lamp 304 when the dimming circuit 350 operates is prevented.

In addition, in normal operations, if the transformer 305 is seriously damaged because of electric leakage, the system will have the problem of overload due to the additional loss caused by the electric leakage. Thus, the error amplifier 311 increases the level of output S3 continuously, so as to provide sufficient power to the load to stabilize the current of the fluorescent lamp. If the electric leakage exceeds the maximum power provided by the system, the output S3 of the error amplifier 311 is definitely higher than a peak of the triangular wave S1. The protection circuit 340 compares the output S3 of the error amplifier 311 and a reference voltage Vref3 slightly higher than the peak of the triangular wave S1, and obtains a signal S14 indicating whether or not the system is overloaded. Similarly, when the timer 330 starts the protection circuit 340 with S11, if the signal S14 indicates that the system is overloaded, and the logic control circuit 341 start to count time by the pulse signal S2 generated by the frequency generator 320. If the system is overloaded for a period exceeding the predetermined time, the logic control circuit 341 sends out the output stop signal S18 to the driving circuit 360.

This embodiment further includes a dimming circuit 350. The dimming principle is using a pulse signal S7 with a frequency lower than the operating frequency of the fluorescent lamp, so as to control to stop or restore transmitting power to the fluorescent lamp. Thus, by alternatively turning on and off the lamp, the luminance of the fluorescent lamp is adjusted. Moreover, to prevent the flicker caused by an over low frequency, generally, the dimming frequency is controlled to be over 200 Hz. The dimming circuit 350 of this embodiment is controlled by the signal S15 indicating whether or not the fluorescent lamp is struck. When the signal S15 indicates that the fluorescent lamp is struck, a switch 353 that controls the output of the dimming signal is turned on.

A dimming voltage S20 of the dimming circuit 350 is higher than the reference voltage Vref1. When the dimming voltage S20 of the dimming circuit is transmitted to the pulse width modulated circuit 310 via the control switches 353, 352, and a resistor 354, the level of output S3 generated by the error amplifier 311 of the pulse width modulated circuit 310 is reduced, so the system stops outputting power to the load. When the dimming pulse signal S9 turns off the switch 352, the dimming voltage S20 is stopped to transmit to the pulse width modulated circuit 310, and the system restores the power supply to the lamp. Thus, the effect of luminance adjustment is achieved by using a low frequency to control the proportion that the power supply is stopped or restored in each period. The dimming circuit 350 starts the dimming function when the fluorescent lamp is struck, so as to ensure adequate and continuous power for striking the fluorescent lamp, such that the fluorescent lamp is struck in a long enough period.

In this embodiment, the dimming circuit 350 is coupled to the inverting input terminal of the error amplifier 311 of the pulse width modulated circuit 310, so as to realize the dimming function. However, in practice, the dimming signal can be sent to other circuit, such as the driving circuit 360, the comparator 312, and so on, to realize the dimming function. These variations are well known to persons of ordinary skill in the art.

The terminal voltage during the striking of the fluorescent lamp changes according to the ambient temperature, lighting, fluorescent lamp types, and fluorescent lamp states. In order to prevent possible misdetermination of the lamp striking only by the lamp voltage, the lamp state indicating signal CS of the conventional art can be used to provide assistance in the determination of the fluorescent lamp state.

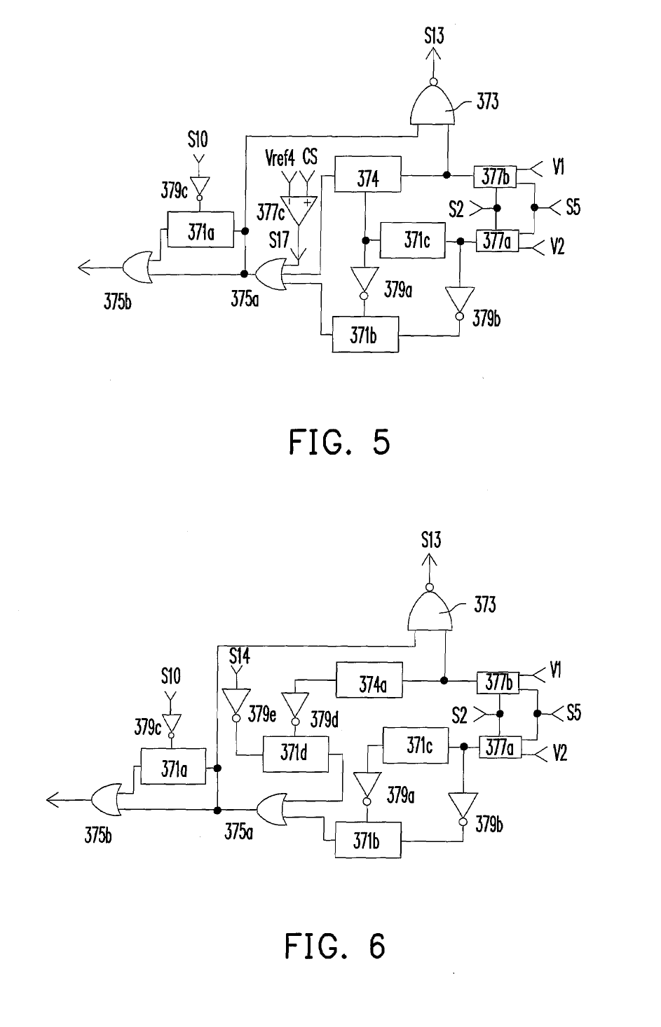

FIG. 5 is another embodiment of the lamp state determining circuit 370 according to the present invention. Referring to FIG. 5, compared to the embodiment of FIG. 4, the lamp state determining circuit 370 further includes a determiner 377c, which compares the lamp state indicating signal CS with a reference voltage Vref4. Here, the lamp state indicating signal CS is a detecting signal for detecting the current of the fluorescent lamp 304. When the lamp state indicating signal CS exceeds the reference voltage Vref4, a high level signal S17 is sent out and passes through the OR logics 375a, 375b, and the high level signal S15 is output. If the striking of the fluorescent lamp is as shown in curve d and the lamp is struck before the predetermined delay time of the delay circuit 374 is reached; or the voltage V2 is set to be too low, it cannot be detected that the terminal voltage of the fluorescent lamp 304 drops between the voltages V1 and V2 when striking. Through the assistant determination of the lamp state indicating signal CS, the above problems can be prevented. The lamp current is difficult to be measured because of the leakage current in the conventional art. Compared with the conventional art, this embodiment is assisted by the detecting signal of the lamp current to make determination of lamp striking. Thus, the misdetermination caused by leakage current is prevented.

FIG. 6 illustrates yet another embodiment of the lamp state determining circuit 370 according to the present invention. Compared to the embodiment of FIG. 4, the lamp state determining circuit 370 further includes inverters 379d, 379e and a latch circuit 371d, so as to determine whether or not the lamp is struck according to the signal S14. If the lamp is struck, the load current signal S4 will increase, such that the output signal S3 of the error amplifier 311 is lower than the reference voltage Vref3 of the comparator 344 in the protection circuit 340, and the signal S14 is at the low level. In other words, after the lamp is struck, as the feedback signal S4 exists, the level of the signal S3 is lower than the peak level of the triangular wave S1.

In this embodiment, the predetermined delay time of the delay circuit 374a is the time required for charging the level of the signal S3 from a trough level of the triangular wave signal S1 to the level of the reference voltage Vref3 when the capacitor 313 is charged by the error amplifier 311. After the predetermined delay time, the latch circuit 371d returns from the reset state to the normal operating state through the inverter 379d. At this time, once the fluorescent lamp 304 is struck to turn the signal S14 to the low level, the high level signal is output through the inverter 379e. Thus, the output signal of the latch circuit 371d is latched at the high level, such that the lamp state determining circuit 370 outputs the high level signal S15 representing that the fluorescent lamp is struck.

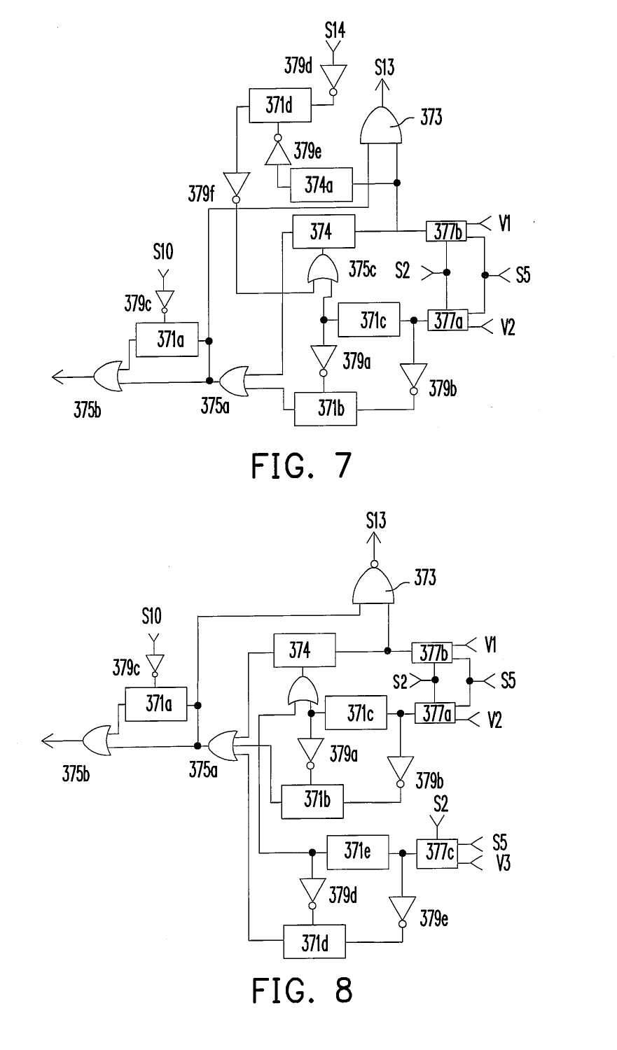

FIG. 7 is still another embodiment of the lamp state determining circuit 370 according to the present invention. Similar to the embodiment of FIG. 6, the signal S14 is used to determine whether or not the lamp is struck, while the difference is that the determination is employed to determine whether or not to turn the delay circuit 374 into the reset state. When the signal S5 exceeds the voltage V1, the delay circuit 374a sends the high level signal out after the predetermined delay time of the delay circuit 374a. The latch circuit 371d starts to operate normally through the inverter 379e. At this time, if the signal S114 is still at the high level, the high level signals are output through the inverter 379d, the latch circuit 371d, and the inverter 379f. Thus, the OR logic 375c outputs the high level signal, and the delay circuit 374 is still in the reset state. Therefore, the situation that the lamp is determined to be struck after the predetermined delay time of the delay circuit 374, but the lamp is determined to be not struck yet, the frequency generator 320 changes frequency from a normal operating frequency to the lamp starting frequency again is prevented.

FIG. 8 illustrates yet another embodiment of the lamp state determining circuit 370 according to the present invention. As the terminal voltage changes during the striking of the lamp according to different situations, and the embodiment of FIG. 4 makes determination according to whether the terminal voltage of the lamp exceeds and then drops below the voltage V2. If the voltage V2 is not chosen properly, the determination will be difficult. Therefore, a plurality of groups of determining voltages can be used to determine the characteristic that the lamp voltage exceeds a certain voltage value before striking and then drops below the voltage value after the striking. In FIG. 8, a determiner 377c and corresponding latch circuits 371d, 371e and inverters 379d, 379e are added to determine the relationship of the changes of the signal S5 and the voltage V3. The determining process is similar to the determining process of the voltage V2 of FIG. 4, and is not described again here.

As known from the description of the above embodiments, of the present invention firstly determines whether the terminal voltage of the lamp exceeds the lowest possible voltage V1 of the normal operation of the lamp, and secondly determines whether or not the lamp is struck according to a predetermined time after the signal S5 exceeds the voltage V1 or the load current signal S4 exceeds a predetermined value (to reduce the level of the signal S3). In the other aspect, the present invention also takes advantage of the characteristic that the terminal voltage increases before striking and drops after striking during the striking process of the lamp, and uses one or more groups of determining circuits to determine whether or not the lamp is struck. Certainly, the present invention can also use the lamp current detecting to assist in determining the lamp state.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A DC/AC inverter for driving a load, comprising:
a switch device, coupled to a DC power source;
a resonant tank, coupled to the switch device and the load, for converting power of the DC power source from the switch device to an AC signal to drive the load;
a voltage detecting circuit, coupled to the load, for generating a voltage detecting signal according to a voltage of the load; and
a controller, coupled to the voltage detecting circuit and the switch device, for controlling a magnitude of the power of the DC power source transmitted to the resonant tank through the switch device;
wherein the controller determines whether or not to change an operating frequency thereof according to the voltage detecting signal.

2. The DC/AC inverter as claimed in claim 1, wherein the controller changes the operating frequency thereof after the voltage detecting signal is greater than a first predetermined value for a first predetermined time.

3. The DC/AC inverter as claimed in claim 1, wherein the controller starts to determine whether or not to change the operating frequency thereof after the voltage detecting signal is greater than a second predetermined value.

4. The DC/AC inverter as claimed in claim 3, wherein the controller changes the operating frequency thereof after the voltage detecting signal is lower than the second predetermined value.

5. The DC/AC inverter as claimed in claim 3, wherein the controller changes the operating frequency thereof after the voltage detecting signal is greater than a third predetermined value and then lower than the third predetermined value, wherein the third predetermined value is greater than the second predetermined value.

6. The DC/AC inverter as claimed in claim 1, wherein the controller further receives a dimming control signal, and starts to adjust the magnitude of the power of the DC power source transmitted to the resonant tank according to the dimming control signal when changing the operating frequency.

7. The DC/AC inverter as claimed in claim 1, wherein the controller further determines whether or not to stop transmitting the power of the DC power source to the resonant tank according to the voltage detecting signal.

8. The DC/AC inverter as claimed in claim 1, wherein the controller stops transmitting the power of the DC power source to the resonant tank if it is determined not to change the operating frequency thereof after a second predetermined time.

9. The DC/AC inverter as claimed in claim 1, further comprising a first current detecting circuit coupled to the load, for generating a first current detecting signal according to a current of the load, wherein the controller adjusts a magnitude of the power of the DC power source transmitted to the resonant tank according to the first current detecting signal.

10. The DC/AC inverter as claimed in claim 9, wherein the controller further determines whether or not to change a operating frequency thereof according to the voltage detecting signal after the first voltage detecting signal is greater than a first predetermined value.

11. The DC/AC inverter as claimed in claim 1, further comprising a second current detecting circuit coupled to the load, for generating a lamp state indicating signal according to the current of the load, wherein the controller further determines whether or not to change a operating frequency thereof according to the lamp state indicating signal after the first voltage detecting signal is greater than a first predetermined value.

12. A controller, for controlling a DC/AC inverter to drive a load, comprising:
a frequency generator, for generating a reference signal;
a pulse width modulated circuit, coupled to the frequency generator, for generating a pulse width modulated signal according to the reference signal;
a driving circuit, coupled to the pulse width modulated circuit, for generating a plurality of driving signals according to the pulse width modulated signal; and
a lamp state determining circuit, comprising a first determining circuit, wherein the first determining circuit determines whether or not to generate a first determining signal according to a voltage detecting signal and a first reference voltage;
wherein the frequency generator determines whether or not to adjust a frequency of the reference signal according to the first determining signal.

13. The controller as claimed in claim 12, wherein the lamp state detecting circuit further comprises a second determining circuit, the second determining circuit determines whether or not to generate a second determining signal according to the voltage detecting signal and a second reference voltage, and the frequency generator determines whether or not to adjust a frequency of the reference signal further according to the second determining signal.

14. The controller as claimed in claim 13, wherein the first determining circuit generates the first determining signal after the voltage detecting signal is greater than the first reference voltage.

15. The controller as claimed in claim 13, wherein the second determining circuit generates the second determining signal when the voltage detecting signal is greater than the second reference voltage and then is lower than the second reference voltage.

16. The controller as claimed in claim 13, wherein the second determining circuit generates a first reset signal to the first determining circuit when the voltage detecting signal is greater than the second reference voltage, and the first determining circuit further determines whether or not to generate the first determining signal according to the first reset signal.

17. The controller as claimed in claim 16, wherein the lamp state detecting circuit further comprises a third determining circuit, the third determining circuit determines whether or not to generate a third determining signal according to the voltage detecting signal and a third reference voltage, and the frequency generator determines whether or not to adjust a frequency of the reference signal further according to the third determining signal.

18. The controller as claimed in claim 17, wherein the third determining circuit generates the third determining signal when the voltage detecting signal is greater than the third reference voltage and then is lower than the third reference voltage.

19. The controller as claimed in claim 18, wherein the third determining circuit generates a second reset signal to the first determining circuit when the voltage detecting signal is greater than the third reference voltage, and the first determining circuit determines whether or not to generate the first determining signal further according to the second reset signal.

20. The controller as claimed in claim 13, wherein the lamp state detecting circuit further comprises a third determining circuit, the third determining circuit determines whether or not to generate a third determining signal according to a lamp state indicating signal and a second reference voltage, and the frequency generator determines whether or not to adjust a frequency of the reference signal further according to the third determining signal, wherein the lamp state indicating signal is used for indicating a current value of the load.

21. The controller as claimed in claim 12, wherein the pulse width modulated circuit generates an error amplifying signal according to a feedback signal and a second reference voltage, and the first determining circuit determines whether or not to generate the first determining signal further according to the error amplifying signal and a third reference voltage.

22. The controller as claimed in claim 13, further comprising a timer, wherein the timer generates a time out signal after reaching a predetermined time.

23. The controller as claimed in claim 22, further comprising a protection circuit coupled to the driving circuit, wherein the protection circuit starts to function according to the time out signal and determine whether or not to send out a protection signal.

24. The controller as claimed in claim 23, wherein the lamp state determining circuit determines whether or not to send an abnormal signal according to the first determining signal and the second determining signal, and the protection circuit receives the abnormal signal and sends out the protection signal accordingly.

25. The controller as claimed in claim 13, further comprising a dimming circuit, wherein the dimming circuit receives a dimming control signal, and determines whether or not to adjust the plurality of driving signals according to the dimming control signal according to the first determining signal and the second determining signal.
